(19) United States
(12) Patent Application Publication
(10) Pub. No.: US 2005/0113199 A1
(43) Pub. Date: May 26, 2005

(54) Toothed belt with tooth reinforcements

(75) Inventor: Rudolph Schoendienst, Brick, NJ (US)

Correspondence Address: LERNER, DAVID, LITTENBERG,;KRUMHOLZ & MENTLIK, 600 SOUTH AVENUE WEST, WESTFIELD, NJ, 07090, US

(73) Assignee: BrecoFlex Co., L.L.C., Eatontown, NJ (US)

(21) Appl. No.: 10/722,778

(22) Filed: Nov. 26, 2003

(51) Int. Cl. F16G 1/28; F16G 5/20

(52) U.S. Cl. 474/251; 474/205

(57) ABSTRACT

A belt assembly including a belt having a plurality of longitudinally extending wires and a plurality of teeth embedded in a surface of the belt. Transverse inserts are disposed in the teeth, and the wires are bonded to the inserts or guided through the inserts.

### FIELD OF THE INVENTION

The present invention relates to a belt assembly. More particularly, the invention relates to a toothed belt having tooth reinforcements connected to wires extending along the length of the belt.

### BACKGROUND OF THE INVENTION

Effective belt assemblies are important in many widely differing sectors of power transmission, transport and linear technology. Increasing demands for smooth running, precise and reliable belt assemblies require more advantageous designs than are presently available. In many applications, mechanically processed and/or coated polymeric belts can provide the reliability and security needed for the special demands of drive, linear, and transport technology.

Reinforced belts made of polyurethane work well in high-accuracy linear motion and conveying applications because in many applications they stretch very little, do not creep or slip, and are much less stiff than belts made from other materials, leading to less tooth deflection. However, in other applications, there is a need for polymeric belts exhibiting increased torsional stiffness. For example, a conveyor for moving large cartridges for transport requires a belt having high torsional stiffness and longitudinal flexibility. Steel belts may be used for such applications, but steel belts have certain disadvantages. One disadvantage is that steel has a tendency to fatigue and break over time. In addition, because steel belts cannot be manufactured in continuous long lengths, longer steel belts are made by adding segments to increase the length of the belt in such long length applications. This process for manufacturing long-length steel belts is time consuming and expensive. Polyurethane belts can be manufactured in long lengths without the structural and manufacturing limitations of steel. U.S. Pat. No. 4,773,896 discloses a V-belt having a plurality of transverse elements having a recess to receive a plurality of cables, and the transverse elements and cable are formed together by an elastomer mass filling the recesses. A bar or other element locks the cables in place, but also permits relative movement of the cable with respect to the transverse element during operation of the belt. There are no polymeric teeth in the belt disclosed in U.S. Pat. No. 4,773,896. U.S. Pat. No. 4,861,323 discloses a belt having wires embedded in the body of the belt, the wires being interlaced with round shafts. A disadvantage of this design is that the wrapping of the wires around the round shafts does not positively lock the wires in place with respect to the shafts. In addition, wrapping of the wires around the round shafts may result in uneven tension distribution across the belt when it is in use.

It would be desirable to provide a toothed belt having the advantages of polymeric and steel belts, namely, the ability to be manufactured in long lengths and having high torsional stiffness. In addition, it would be desirable to provide a reinforced toothed polymeric belt in which the teeth exhibit improved shear strength.

### SUMMARY OF THE INVENTION

In accordance with one or more embodiments of the present invention, a belt assembly is provided comprising a belt having a longitudinal axis, first side and a second side. Wires extend along the longitudinal axis of the belt. A plurality of teeth on either the first or second side of the belt extend transversely to the wires, and inserts are disposed in the teeth. Wires run through a portion of the inserts or are bonded to the inserts so that the shear strength of the teeth is improved and the wires run in a linear path, thus evenly distributing tension across the belt. According to certain embodiments, the belt is a truly endless belt or a joined belt (for example, spliced in sections) with the teeth on one side of the belt. In other embodiments, the belt is an open-ended and clamped belt. In some embodiments, the one side of the belt is flat. Such belts may be referred to as single sided belts, meaning that teeth are only associated with a single side of the belt. However, in other embodiments, the teeth are on first and second sides of the belt, and the teeth on the second side of the belt may or may not include inserts therein. Such belts may be referred to as double sided belts, meaning that teeth may be associated with both sides of the belt.

According to preferred embodiments, the wires are made from metal, for example, steel. Preferably, the inserts are also made from a metal such as steel. In certain preferred embodiments in which the inserts and the wires are both made from metal, the wires and the inserts are bonded by metal-to-metal bonding. The metal-to-metal bonding can be achieved by inductive welding, ultrasonic welding, or chemical bonding the wires and the inserts together.

### BREIF DESCRIPTION OF THE DRAWINGS

A more complete appreciation of the subject matter of the present invention and the various advantages thereof can be realized by reference to the following detailed description in which reference is made to the accompanying drawings in which:

FIG. 1 is a perspective view of a belt assembly according to one embodiment of the invention;

FIG. 2 is a disassembled perspective view of the wires and the inserts of a belt according to one embodiment of the invention;

FIG. 3 is a longitudinal cross-sectional view of the belt taken along line 3-3 of FIG. 1;

FIG. 4 is a cross-sectional view of the belt taken along line 4-4 of FIG. 1; and

FIGS. 5A-C show various belts and applications according to one or more embodiments of the invention.

### DETAILED DESCRIPTION OF EXEMPLARY EMBODIMENTS

Before describing several exemplary embodiments of the invention, it is to be understood that the invention is not limited to the details of construction or process steps set forth in the following description. The invention is capable of other embodiments and of being practiced or carried out in various ways.

One or more embodiments of the invention relates to a belt assembly comprising a belt having first and second sides and teeth formed on both the first and second sides of the belt. Wires extending along a longitudinal axis of the belt are bonded to inserts or run through a portion of the inserts in the teeth of the belt. The wires run in a linear path such that there is an even tension distribution across the belt when the belt is in use. The inserts improve the shear strength of the teeth. In embodiments in which the inserts are bonded to the wires, the bonding of the inserts to the wires prevents relative movement between the inserts and the wires when the belt is in use and under tension. According to one or more embodiments, such a design provides a belt exhibiting improved torsional stiffness, thus allowing polymeric belts to be used in applications that were traditionally served by all metal chains or belts and not by conventional neoprene or polyurethane belts. The inserts used herein should have a tensile strength that is greater than the material that forms the teeth in the belt. Examples of suitable materials to form the inserts include fiber reinforced polyurethane and metal such as steel. The wires should also have high tensile strength. Examples of suitable materials for the wires include aramide fibers such as Kevlar® or metal such as steel.

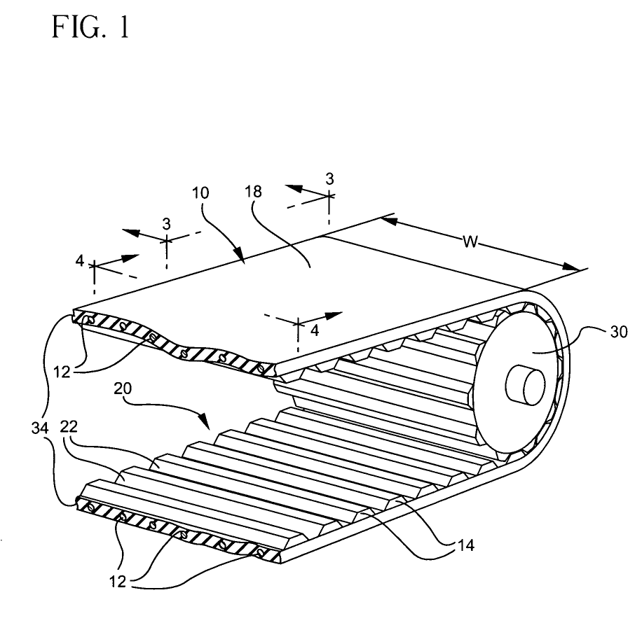

Referring now to the Figures, and in particular FIGS. 1-4, a belt 10 is shown having longitudinal wires 12 extending through the belt. The belt 10 includes an second or back side 18, an first side 20 providing a driving surface in contact with a pulley or other drive mechanism and has a width W as shown in FIG. 1. According to the embodiment shown in FIG. 1, the belt 10 has a plurality of teeth 14 on the first side 20 or driving surface. The teeth 14 may engage a pulley 30 or other suitable drive device that may be connected to a motor (not shown). In a typical arrangement, the belt 10 is in an endless or loop configuration and at least a second pulley or other suitable drive device is provided for driving and maintaining tension on the belt. However, the belt could be in other configurations such as in an open-ended and clamped configuration.

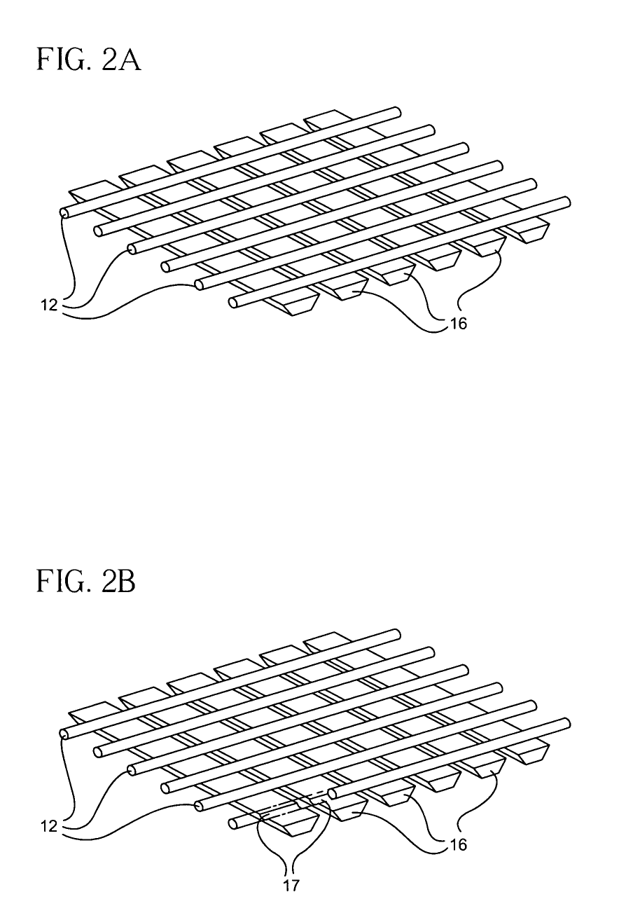

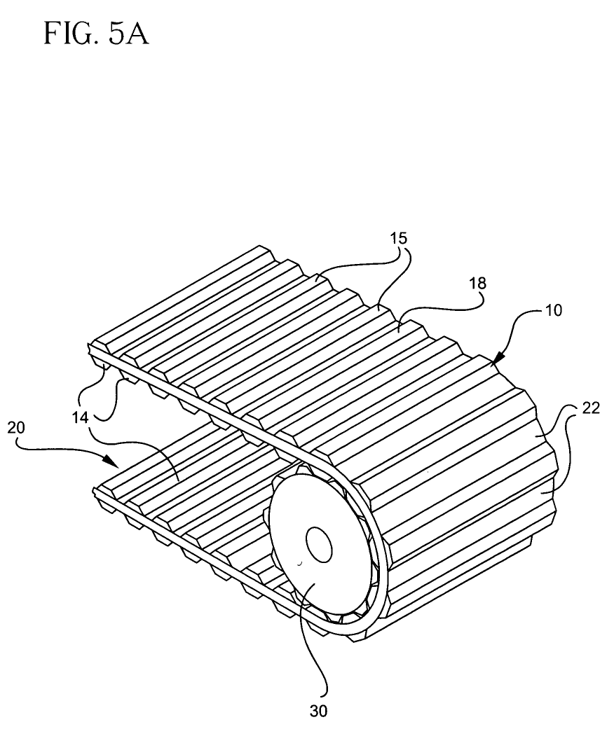

Referring now to FIGS. 2-4, at least a portion of the teeth 14, include inserts 16 disposed in the teeth 14, which increases the shear strength of the teeth. In other embodiments, the inserts are disposed in all of the teeth. In the embodiment shown, each of the teeth 14 includes an insert 16. However, the present invention is not limited to a configuration in which each tooth has an insert. According to certain embodiments, alternating teeth may include an insert. FIG. 2 shows an embodiment in which a single insert 16 extends across the entire width of the belt 10. It will be understood that other variants are possible. For example, the inserts 16 may extend only across a portion of the width of the belt. In the embodiment shown in FIG. 2A, the inserts 16 are bonded to the wires 12. In the embodiment shown in FIG. 2B, wires 12 run through a portion of the inserts 14 in a linear, uninterrupted path. The inserts 16 have grooves or tracks 17 that guide the wires 12 in a linear path and prevent the wires from drifting when under tension. In FIG. 2B, one of the wires is shown in phantom to show the groove or track 17 in each of the inserts 14. The inserts 16 may have the same cross-sectional shape as the teeth 14, or they may have a cross-sectional shape that differs from the teeth 14. For ease of illustration, only six wires are shown running through the belt in FIG. 4. It will be understood, of course, that the invention is not limited to any number of wires running through the belt. In commercially manufactured belts, a belt having width of 100 mm may have as many as between thirty and eighty wires running through the belt.

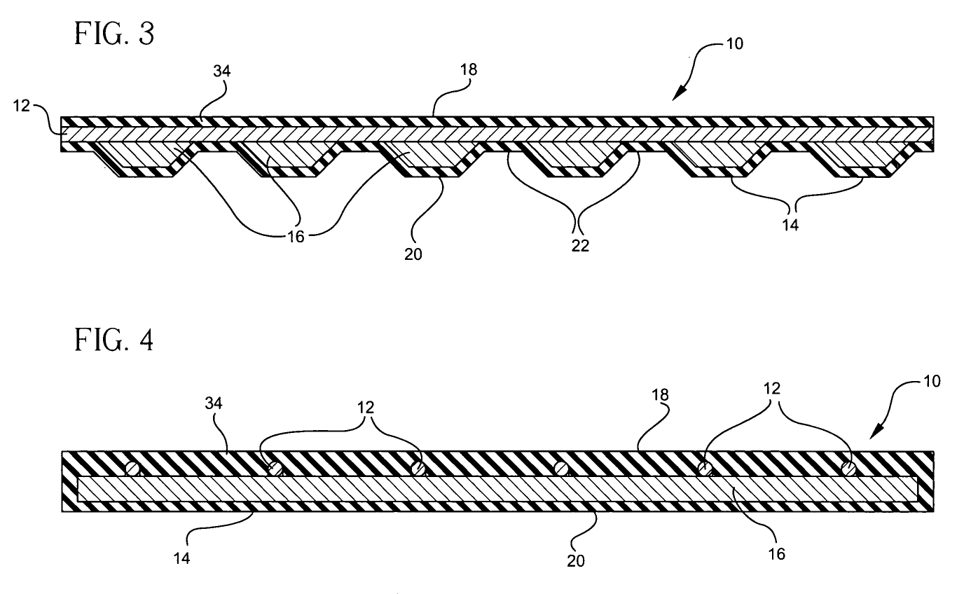

The belt 10 is preferably made from a polymer such as a polyurethane using techniques known in the art. In the embodiment shown, the first side 20 of the belt includes alternating teeth 14 and grooves 22 between the teeth 14. The size and pitch of the teeth will depend on the desired final end use and properties of the belt. Similarly, the shape of the teeth will vary depending on the particular application for which the belt is used. According to certain embodiments, the cross-sectional shape of the teeth and the inserts can be substantially the same. For both cost and manufacturing reasons the cross section of the insert can be symmetric. In preferred embodiments, the teeth 14 are positioned substantially transversely to the longitudinal axis 24 of the belt 10. In preferred embodiments, the inserts 16 are made from a metal such as steel, and the longitudinally extending wires 12 are also made from a metal such as steel. The longitudinal wires and the inserts to which they are bonded are surrounded by polymeric material as shown in FIGS. 3 and 4. The wires 12 and the inserts 16 are thus embedded in the polymeric material that forms the belt 10.

In some embodiments, the bond between the metal inserts 16 and the longitudinal wires 12 is a metal-to-metal bond. Such a bond may be achieved by a variety of techniques including but not limited to inductive welding, ultrasonic welding, chemical bonding, or any other suitable method for achieving a metal-to-metal bond. In preferred embodiments, the bond of the longitudinal wires 12 to the metal inserts 16 is friction-locked to provide prevent slipping between the inserts 16 and the longitudinal wires 12. In other words, relative movement between the inserts and the teeth is prevented by bonding the teeth to the inserts. Such a design results in a belt that exhibits reduced tooth deflection.

Running the wires through the inserts or bonding the wires to the inserts provides a belt having superior tooth shear strength. In addition, in many applications, even tension distribution is desired among all longitudinal wires 12 extending across the width W of the belt 10. Running the wires through a portion of the inserts or bonding between the inserts 16 and the wires 12 provides equalized power distribution across the width of the belt, thereby preventing unequal tension across the width of the belt and cambering. This provides a belt that runs straight and does not walk off the pulley. In addition, by bonding the wires 12 to the inserts 16 or running the wires through the inserts, the wires run along the length of the belt in an uninterrupted and linear path, which further facilitates smooth running of the belt when it is under tension. In other words, with reference to FIGS. 2A and 2B, when looking at the wires in the belt from a top view, each of the wires runs in a straight line and has a continuous track along a top surface of the insert. Bonding of the wires to the inserts also provides tension relief on the wires, which can prevent fatigue of the wires in the belt.

In the embodiment shown in FIGS. 1-4, the second or back side 18 of the belt is flat. However, the present invention should not be limited to any particular belt profile or design. It is within the scope of the invention for both the first side 20 and the second or back side 18 of the belt may have teeth thereon.

As noted above, the belt of the present invention provides a polymeric belt having improved torsional stiffness. Such a design enables the use of polymeric belts in a wider variety of applications. Polymer belts can be made in a more compact design and be used in high torque applications.

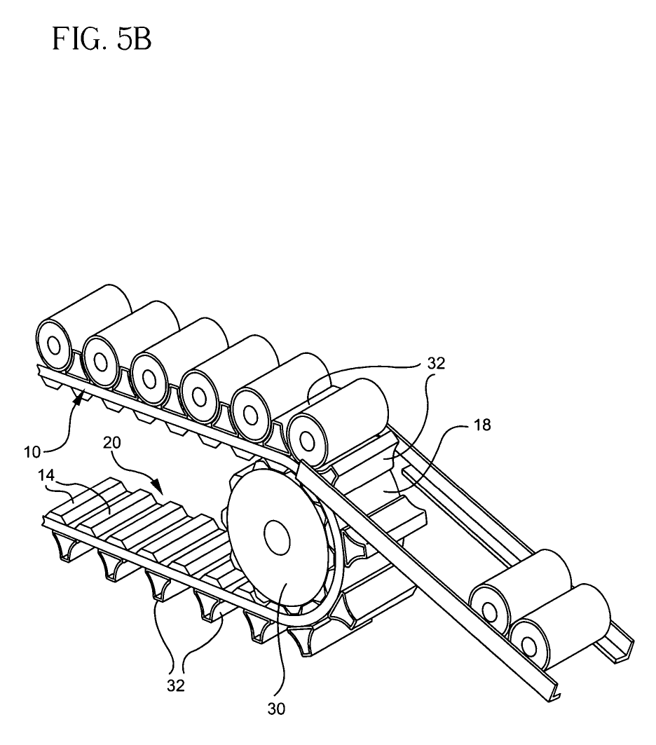

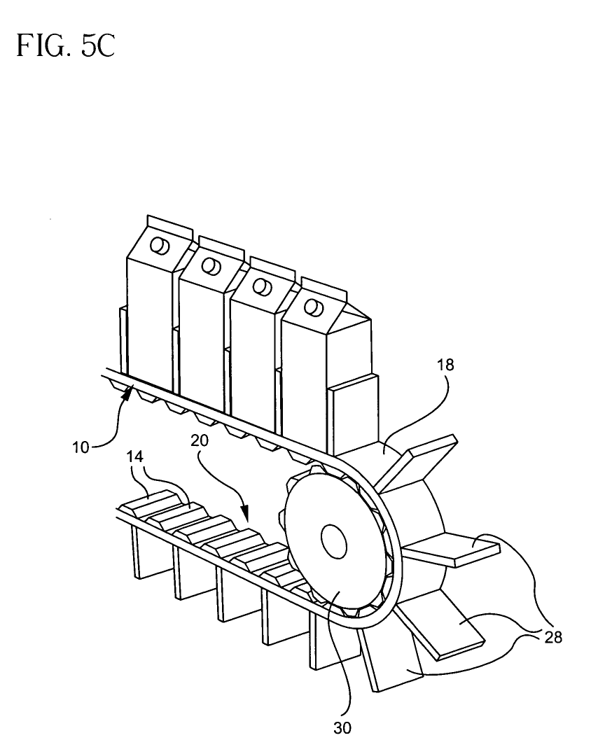

FIGS. 5A-D shows various belts and applications according to one or more embodiments in which a belt requiring high torsional stiffness may be required. FIG. 5A shows belt 10 with teeth 14 on a first side 20 of the belt and teeth 15 on second or back side 18 of the belt 10. It will be understood that while the teeth 15 on the second or back side of the belt are shown as being aligned with the teeth 14 on the first side 20 of the belt, the invention is not limited to such a configuration. In one or more embodiments, the teeth 14 on the first side 20 may be staggered in location from the teeth 15 on the second side 18. The first side 20 of belt 10 is in contact with and in driving engagement with pulley device 30. The teeth 14 on the first side 20 of the belt have inserts embedded therein. Longitudinal wires extending along the longitudinal axis of the belt run through or are bonded to the inserts, providing a belt with improved tooth shear strength.

FIG. 5B shows belt 10 having a first side 20 in driving engagement with a pulley 30. The first side 20 of the belt includes teeth 14 having inserts embedded therein, the inserts being bonded to longitudinal wires embedded in the belt. Alternatively, the wires can run through a portion of the inserts. The second or back side 18 of the belt 10 includes profiled elements 32 on the second or back side 18 for transporting and moving cylindrical objects, such as oil filters, drums, or food containers. Profiled elements 32 may be of variable size and shape, and may be spaced according to the particular application for the belt.

FIG. 5C shows belt 10 having a first side 20 with teeth formed thereon and an second or back side. The first side 20 is in contact with and driven by pulley device 30. A second or back side 18 of the belt includes vertical spacer elements 28 attached for transporting and moving objects, such as square containers. The vertical spacer elements 28 may be of variable size and shape, and may be spaced according to the needed use of the belt.

Although the invention herein has been described with reference to particular embodiments, it is to be understood that these embodiments are merely illustrative of the principles and applications of the present invention. For example, a wide variety of belt profiles and configurations can be provided in addition to the profiles described herein. The belts can be used in a wide variety of applications, including, but not limited to high torque power transmission applications due to the increased shear strength of the teeth and indexing and conveying applications that required toothed belts with high tooth shear strength. Polyurethane timing belts with tooth reinforcement are preferably used for power transmission applications due to the increased tooth shear strength, resulting in higher torque (Nm), higher power (kW), and higher peripheral force (N) than belts without tooth reinforcements. It is therefore to be understood that numerous modifications may be made to the illustrative embodiments and that other arrangements may be devised without departing from the spirit and scope of the present invention as defined by the appended claims and their equivalents.

1. A belt assembly comprising:
a belt having a longitudinal axis and a plurality wires extending along the longitudinal axis;
a plurality of teeth extending transversely to the wires; and
inserts disposed in the teeth, the wires guided through a portion of the inserts or bonded to the inserts such that the teeth exhibit improved shear strength and the wires run in a linear path.

2. The assembly according to claim 1, wherein the belt is an endless belt with the teeth on a first side of the belt.

3. The assembly of claim 2, wherein belt has a second or back side that is flat.

4. The assembly of claim 2, further comprising a plurality of teeth on the second side of the belt.

5. The assembly of claim 1, wherein the wires are made of metal.

6. The assembly of claim 5, wherein the wires are made of steel.

7. The assembly of claim 1, wherein the inserts include metal.

8. The assembly of claim 7, wherein the metal includes steel.

9. The assembly of claim 8, wherein the inserts are made of metal.

10. The assembly of claim 9, wherein the wires are bonded to the inserts and the wires and the inserts are bonded by metal-to-metal bonding.

11. The assembly of claim 10, wherein the metal-to-metal bonding is achieved by inductive welding, ultrasonic welding, or chemical bonding the wires and the inserts together.

12. The assembly of claim 11, wherein the bond between the wires and the inserts results in a friction-locked bond between the wire and belt.

13. The assembly of claim 7, wherein the inserts are covered by polymer.

14. The assembly of claim 13, whereby the polymer is polyurethane.

15. The assembly of claim 1, wherein the belt is made from polyurethane.

16. The assembly of claim 1, wherein the shape of the insert is substantially the same as the shape of the tooth.

17. A belt assembly, comprising:
a polymeric belt having a longitudinal axis, a first side and a second side;
a plurality of teeth on the first side;
a plurality of longitudinally extending wires embedded in the belt; and
inserts embedded in the teeth and the wires running through the inserts or bonded to the inserts to prevent relative movement between the wires and the teeth.

18. The assembly of claim 18, wherein the inserts and wires are made of metal.

19. The assembly of claim 19, wherein the bonding between the inserts and teeth is metal-to-metal.

20. A belt assembly comprising:
a belt having a longitudinal axis, a plurality of metal wires extending along the longitudinal axis embedded in the belt;
a plurality teeth formed on a driving surface of the belt; and
metal inserts embedded in the plurality of teeth, the wires running through or bonded to the inserts in a linear path so that when the belt is under tension, the tension is substantially equal on each of the wires and the teeth do not move relative to the wires.

21. The assembly of claim 20, wherein the bonding is between the inserts and the wires is metal-to-metal.
